(19) United States
(12) Patent Application Publication
(10) Pub. No.: US 2026/0312474 A1
(43) Pub. Date: Oct. 8, 2026

(54) METHOD FOR MANUFACTURING LAMINATED IRON CORE

(71) Applicant: Mitsui High-tec, Inc., Kitakyushu-shi, Fukuoka (JP)

(72) Inventors: Shinya SHIBATA, Fukuoka (JP); Jin ODA, Fukuoka (JP); Akinori MIZUNO, Fukuoka (JP)

(21) Appl. No.: 18/998,494

(22) PCT Filed: Jul. 26, 2023
(86) PCT No.: PCT/JP2023/027401

§ 371 Date: Jan. 25, 2025

(30) Foreign Application Priority Data
Jul. 27, 2022 (JP) 2022-119741

(51) Int. Cl. H02K 15/90; H02K 15/027; H02K 15/0273; H02K 15/0278

(52) U.S. Cl. CPC H02K 15/90; H02K 15/027; H02K 15/0273; H02K 15/0278

(57) ABSTRACT

A method for manufacturing a laminated iron core includes: forming iron core members by punching a metal sheet along a predetermined shape; and laminating the iron core members on a jig. The jig includes a first positioning portion and a second positioning portion disposed at different positions in a circumferential direction around a predetermined axis. The first positioning portion is configured to regulate a position of a first portion of each of the iron core members in the circumferential direction. The second positioning portion is configured to regulate a position of a second portion of each of the iron core members in the circumferential direction. In the laminating, the iron core members are laminated on the jig such that a gap is provided between the first portion and the first positioning portion and a gap is provided between the second portion and the second positioning portion.

### TECHNICAL FIELD

The present disclosure relates to a method for manufacturing a laminated iron core.

### BACKGROUND ART

Patent Literature 1 discloses a manufacturing method of a stator core. The manufacturing method includes a laminating step of laminating and positioning a plurality of plate members in an axial direction on a positioning jig including a radially positioning portion for positioning a radial position of a ring-shaped portion of each of the plate members and a circumferentially positioning portion for positioning a circumferential position of a tooth portion of each of the plate members.

### CITATION LIST

### Patent Literature

Patent Literature 1: JP2012-249485A

### SUMMARY OF INVENTION

### Technical Problem

The present disclosure provides a method for manufacturing a laminated iron core that is useful in reducing lamination misalignment.

### Solution to Problem

A method for manufacturing a laminated iron core according to an aspect of the present disclosure includes a forming step of forming a plurality of iron core members by punching a metal sheet MS along a predetermined shape; and a laminating step of laminating the plurality of iron core members on a jig, the jig including a first positioning portion and a second positioning portion arranged at different positions in a circumferential direction around a predetermined axis. The first positioning portion is configured to regulate a position of a first portion of each of the plurality of iron core members in the circumferential direction. The second positioning portion is configured to regulate a position of a second portion of each of the plurality of iron core members in the circumferential direction. In the laminating step, the plurality of iron core members are laminated on the jig such that a gap is provided between the first portion and the first positioning portion and a gap is provided between the second portion and the second positioning portion.

### Advantageous Effects of Invention

According to the present disclosure, a method for manufacturing a laminated iron core that is useful in reducing lamination misalignment is provided.

### BRIEF DESCRIPTION OF DRAWINGS

FIG. 1 is a perspective view showing an example of a laminated iron core. FIG. 2A is an exploded perspective view of a laminate constituting the laminated iron core shown in FIG. 1.

FIG. 2B is a schematic diagram showing an example of a cross section of the laminate.

FIG. 3 is a schematic diagram showing an example of a manufacturing device for the laminated iron core.

FIG. 4A is a perspective view schematically showing an example of a jig.

FIG. 4B is a perspective view schematically showing an example of a state in which the laminate is formed on the jig.

FIG. 5 is a top view schematically showing an example of a state in which the laminate is formed on the jig.

FIG. 6A is a side view schematically showing an example of a positional relationship between a pair of tooth portions and a positioning member.

FIG. 6B is a side view schematically showing an example of a positional relationship between the pair of tooth portions and the positioning member.

FIG. 7A is a top view schematically showing an example of the positioning member in a state in which the laminate is formed on the jig.

FIG. 7B is a side view schematically showing an example of a state in which the laminate is pressurized.

FIG. 8A is a schematic view showing an example of a state in which the laminate is formed on the jig.

FIG. 8B is a schematic view showing an example of a state in which the laminate is formed on the jig.

FIG. 9A is a schematic view showing an example of a state in which the laminate is formed on the jig.

FIG. 9B is a schematic view showing an example of a state in which the laminate is formed on the jig.

### DESCRIPTION OF EMBODIMENTS

Hereinafter, an embodiment will be described with reference to the drawings. In the description, the same elements or elements having the same functions are denoted by the same reference numerals, and redundant description thereof is omitted. In the present description, when referring to “upper”, “lower”, “right”, or “left” in a figure, the direction of the symbol in the figure is used as a reference.

### Laminated Iron Core

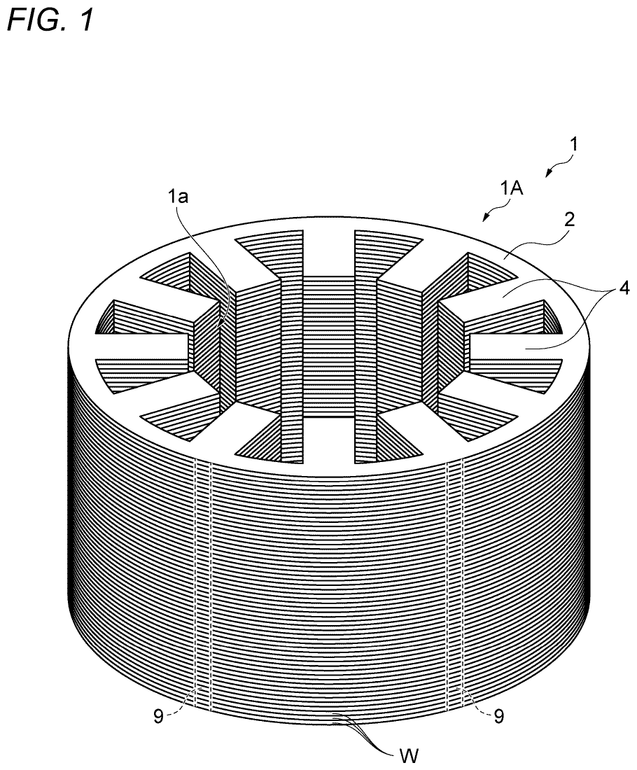

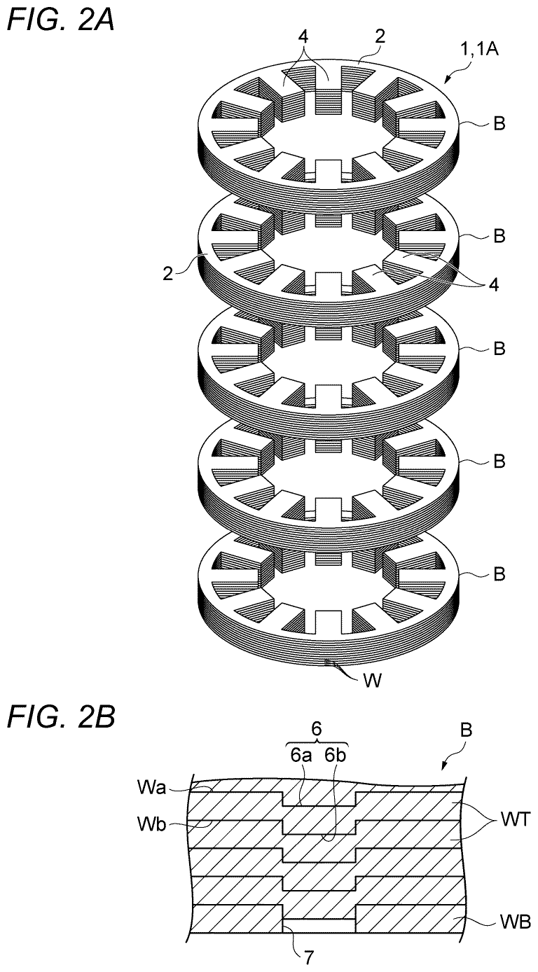

First, a laminated iron core 1 according to an embodiment will be described with reference to FIGS. 1, 2A and 2B. A laminated iron core 1 is a laminated iron core for a motor or an intermediate product in a manufacturing process thereof. The laminated iron core 1 is, for example, a core for a stator (stator laminated iron core) of a motor as shown in FIG. 1. The stator (stator) of the motor is formed by attaching a winding to the laminated iron core 1 shown in FIG. 1. A motor (electric motor) is formed by combining the stator (stator) and the rotor (rotor). Hereinafter, a case in which the laminated iron core 1 is a stator laminated iron core will be described as an example.

The laminated iron core 1 has a tubular shape as a whole. A through hole la extending along a central axis of the laminated iron core 1 is provided in a central portion of the laminated iron core 1. The through hole la extends in a height direction of the laminated iron core 1. The rotor can be disposed in the through hole la. The laminated iron core 1 constitutes a motor together with a rotor core. The laminated iron core 1 includes, for example, a laminate 1A and weld beads 9.

The laminate 1A is formed by laminating (stacking) a plurality of block bodies B. In the laminate 1A shown in FIG. 2A, five block bodies B are laminated. A lamination direction of the laminate 1A is also a height direction of the laminate 1A and is also an extending direction of a central axis of the laminate 1A. The central axis of the laminate 1A corresponds to the central axis of the laminated iron core 1. Hereinafter, the lamination direction of the laminate 1A is simply referred to as a “lamination direction”.

Each of the block bodies B (iron core member) is formed by laminating a plurality of punched members W. The block body B is a laminate formed by laminating a plurality of punched members W. The punched member W is a plate-shaped body formed by punching a metal sheet MS (for example, an electromagnetic steel plate) to be described later along a predetermined shape. The punched member W has a shape corresponding to the laminate 1A (block body B). The laminate 1A may be formed by so-called rotational lamination of the plurality of block bodies B.

The “rotational lamination” refers to relatively shifting angles of the plurality of block bodies B when laminating the plurality of block bodies B to obtain the laminate 1A, and includes lamination while rotating the block bodies B. A main purpose of the rotational lamination is to reduce a plate thickness deviation among the plurality of punched members W constituting the laminate 1A. The plurality of block bodies B are laminated while relatively shifting each of the angles of the plurality of block bodies B (each of circumferential positions of reference positions of the plurality of block bodies B). The plurality of block bodies B may be laminated in order such that the reference positions of the block bodies B adjacent to each other in the laminate 1A are different by a certain angle. The certain angle may be 360°/N (N is a natural number of two or more). N may be a natural number of 3 or more, and in one example, the certain angle is 120°, 90°, or 72°. The certain angle may be 180° (N may be 2).

Each of the plurality of block bodies B includes a yoke portion 2 and a plurality of tooth portions 4. The yoke portion 2 is a portion formed in a ring shape. The yoke portion 2 may have a circular ring shape. The plurality of tooth portions 4 are portions extending to intersect the yoke portion 2. The plurality of tooth portions 4 each extend inward from an inner edge of the yoke portion 2. The plurality of tooth portions 4 each protrude from the inner edge of the yoke portion 2 toward the central axis of the laminate 1A. The plurality of tooth portions 4 may be arranged at substantially equal intervals in a circumferential direction of the yoke portion 2 (an extending direction of the yoke portion 2). A space (slot) for arranging a winding is formed between the tooth portions 4 adjacent to each other in the circumferential direction of the yoke portion 2.

In the block body B, the plurality of punched members W may be connected to each other by caulking portions. As shown in FIG. 2B, the plurality of punched members W constituting the block body B include a plurality of punched members WT laminated on each other and a punched member WB further laminated on the plurality of punched members WT. The punched member WB is located on an outermost layer (for example, a lowermost layer shown in FIG. 2B) of the block body B.

Each of the punched members WT may include a caulking portion 6. The caulking portion 6 includes a recess portion 6a formed on a main surface Wa of the punched member WT and a projection portion 6b formed on a main surface Wb of the punched member WT. The punched members WT are laminated such that the main surface Wa and the main surface Wb face each other. At a boundary between the adjacent punched members WT, the projection portion 6b of one punched member WT is fitted into the recess portion 6a of another punched member WT. Thus, the punched members WT are connected to each other. The punched member WB is different from the punched member WT in that a through hole 7 is formed instead of the caulking portion 6. The punched member WB is laminated so as to face the main surface Wb on which the projection portion 6b of the punched member WT is formed. At a boundary between the punched member WT and the punched member WB, the projection portion 6b of the punched member WT is fitted into the through hole 7 in the main surface Wb. Thus, the punched member WT and the punched member WB are connected to each other.

As shown in FIG. 1, the weld beads 9 are formed on an outer surface of the laminate 1A. The weld beads 9 are formed by welding the plurality of block bodies B to each other after the laminate 1A is formed by laminating the plurality of block bodies B to each other. Each of the weld beads 9 may extend linearly as a whole from one end surface (for example, an upper end surface) to the other end surface (for example, a lower end surface) of the laminate 1A along the lamination direction of the laminate 1A. Unlike the example shown in FIG. 1, the weld bead 9 may be partially formed in the vicinity of the boundary between the adjacent block bodies B. The plurality of block bodies B arranged in the lamination direction are fixed to each other by the welding forming the weld beads 9.

### Manufacturing Device for Laminated Iron Core

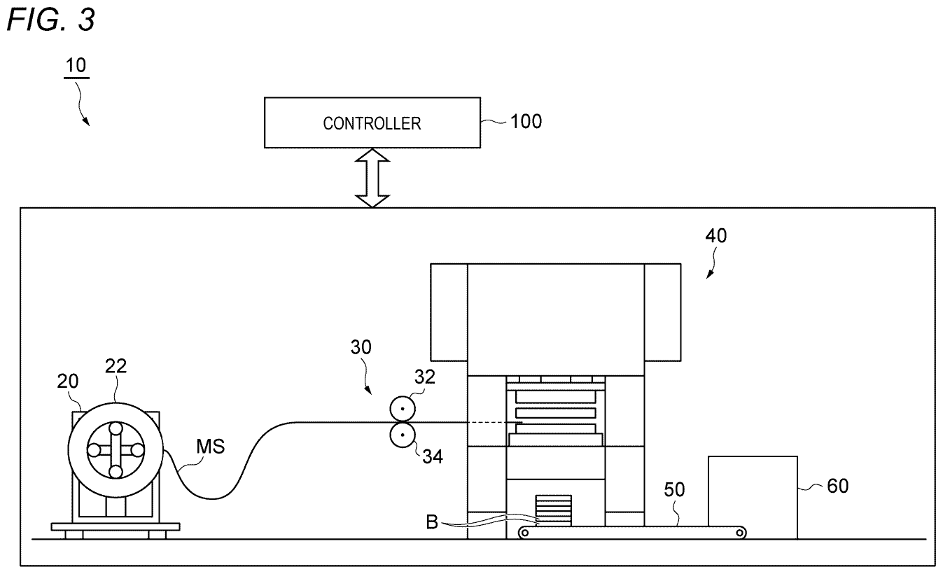

Next, a manufacturing device 10 (manufacturing device of a laminated iron core) for manufacturing the laminated iron core 1 will be described with reference to FIG. 3. The manufacturing device 10 is configured to manufacture the laminated iron core 1 from the belt-shaped metal sheet MS. The manufacturing device 10 includes, for example, an uncoiler 20, a feeding device 30, a pressing device 40, a conveyor 50, a welding device 60, and a controller 100.

The uncoiler 20 is configured to rotatably hold a coil material 22. The coil material 22 is formed by winding the metal sheet MS in a coil shape (spiral shape). The feeding device 30 includes a pair of rollers 32 and 34 that sandwich the metal sheet MS from above and below. The pair of rollers 32 and 34 are configured to rotate and stop based on an operation instruction from the controller 100, and intermittently feed the metal sheet MS toward the pressing device 40.

The pressing device 40 is configured to operate based on an operation instruction from the controller 100 and punch the metal sheet MS along a predetermined shape to form a plurality of the punched members W. The pressing device 40 is configured to, for example, form a plurality of punched members W by sequentially punching or cutting and bending the metal sheet MS fed by the feeding device 30 using a plurality of punches. The pressing device 40 may be configured to form the block body B by sequentially laminating the plurality of punched members W obtained by the punching. The conveyor 50 conveys the block body B formed by the pressing device 40 toward the welding device 60. Unlike the example shown in FIG. 3, the obtained block body B may be manually conveyed to the welding device 60 instead of using the conveyor 50.

The welding device 60 is configured to operate based on an operation instruction from the controller 100 and perform a welding operation on the laminate 1A configured by laminating the plurality of block bodies B. In the manufacturing device 10 shown in FIG. 3, the laminated iron core 1 is manufactured by performing welding on the laminate 1A after the laminate 1A is formed in the welding device 60. Details of the welding device 60 will be described later.

The controller 100 is a computer that controls each device included in the manufacturing device 10. The controller 100 is configured to generate a signal for causing the feeding device 30, the pressing device 40, the conveyor 50 and the welding device 60 to operate based on, for example, a program recorded in a recording medium or an operation input from an operator. The controller 100 is configured to transmit signals to the feeding device 30, the pressing device 40, the conveyor 50, and the welding device 60.

### Welding Device

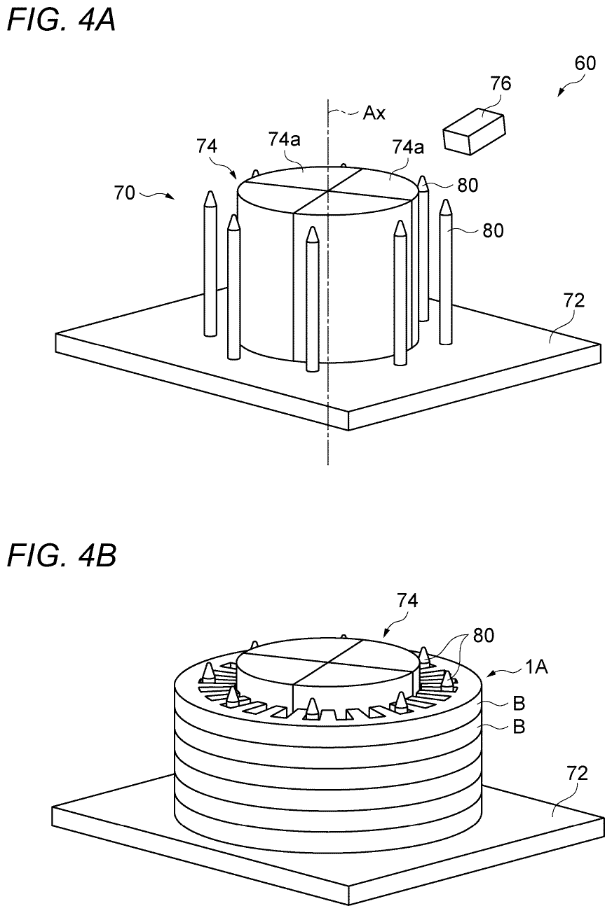

Next, the welding device 60 will be described with reference to FIGS. 4A to 6B. The welding device 60 includes, for example, a welding jig 70 and a welding machine 76. The welding jig 70 (jig) is a jig used to laminate the plurality of block bodies B to form the laminate 1A. The welding jig 70 is formed such that the plurality of block bodies B can be laminated on the welding jig 70. The welding jig 70 has a function of positioning the respective block bodies B when laminating the plurality of block bodies B. The welding jig 70 has a function of positioning each block body B in a circumferential direction around the central axis of the block body B. The welding jig 70 may further have a function of positioning each block body B in a radial direction of a circle centered on the central axis of the block body B. By positioning the plurality of block bodies B in a certain direction, a positional difference (lamination misalignment) between the plurality of block bodies B in the certain direction can be reduced.

The welding jig 70 includes, for example, a lower plate 72, a diameter-increasing member 74, and a plurality of positioning members 80. As shown in FIG. 4A, the lower plate 72 is a member formed in a plate shape. The lower plate 72 is configured to support the plurality of block bodies B (laminate 1A) placed on an upper surface of the plate. The lower plate 72 may have a square shape in a top view as in the example shown in FIG. 4A, or may have another shape such as a circular shape, unlike the example shown in FIG. 4A. The upper surface of the lower plate 72 is larger an area in an outer edge of the punched member W constituting the block body B.

The diameter-increasing member 74 has a function of positioning the plurality of block bodies B in the radial direction when forming the laminate 1A on the welding jig 70. The diameter-increasing member 74 is provided on the upper surface of the lower plate 72 (for example, substantially at a center of the upper surface in a top view). As shown in FIG. 4A, the diameter-increasing member 74 may be formed in a columnar shape. The diameter-increasing member 74 includes a plurality of expansion and retraction portions 74a obtained by dividing the columnar body. Each of the expansion and retraction portions 74a is formed in a fan shape in a top view. The expansion and retraction portion 74a may be provided to be movable along a radial direction of a circle centered on a predetermined axis Ax. The axis Ax may substantially coincide with a center of a circle of the diameter-increasing member 74 in a top view. An apex (a center of the arc) of each of the plurality of fan-shaped expansion and retraction portions 74a may overlap the axis Ax. The axis Ax is a virtual axis perpendicular to the upper surface of the lower plate 72.

The plurality of positioning members 80 have a function of positioning the plurality of block bodies B in the circumferential direction around the axis Ax when laminating the plurality of block bodies B on the welding jig 70. The plurality of positioning members 80 are provided on the lower plate 72. The plurality of positioning members 80 are disposed to surround the axis Ax (the diameter-increasing member 74). The plurality of positioning members 80 are disposed at different positions in the circumferential direction around the axis Ax (a circumferential direction of a circle centered on the axis Ax).

The plurality of positioning members 80 may be disposed on a circumference centered on the axis Ax. In this case, the plurality of positioning members 80 may be arranged at any intervals on the circumference, and for example, may be arranged at substantially equal intervals. The plurality of positioning members 80 may be disposed at positions at which distances to the axis Ax are different from one another. The plurality of block bodies B are laminated on the welding jig 70 such that the axis Ax substantially coincides with the central axis of the block body B. In a state in which the plurality of block bodies B are laminated on the welding jig 70, the circumferential direction around the axis Ax and the circumferential direction around the central axis of the block body B substantially coincide with each other, and hereinafter, the circumferential directions are simply referred to as a “circumferential direction”. The radial direction of the circle centered on the axis Ax and the radial direction of the circle centered on the central axis of the block body B (a direction in which the tooth portion 4 extends) are simply referred to as a “radial direction”.

The welding jig 70 may include three or more, four or more, or six or more positioning members 80. Each of the plurality of positioning members 80 may be formed in a columnar shape so as to extend along the axis Ax. Each of the plurality of positioning members 80 may be positioned between any pair of tooth portions 4 (a pair of tooth portions 4 adjacent to each other) in the block body B when the block body B is placed on the lower plate 72. As shown in FIG. 4B, the block bodies B are laminated on the welding jig 70 such that the diameter-increasing member 74 is inserted into the through hole of each of the block bodies B corresponding to the through hole la and the positioning member 80 is inserted between the pair of tooth portions 4. Each of the plurality of positioning members 80 regulates circumferential position of a corresponding pair of tooth portions 4 (a pair of tooth portions 4 sandwiching the positioning member 80 therebetween) when the plurality of block bodies B are laminated on the welding jig 70.

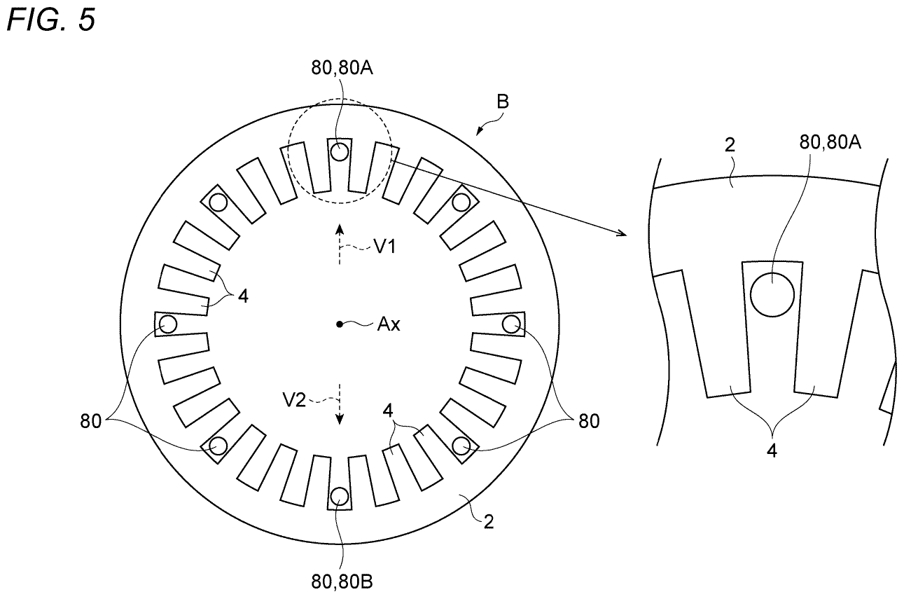

FIG. 5 is a top view showing a positional relationship between the block body B and the plurality of positioning members 80 when the plurality of block bodies B are laminated on the welding jig 70. Each of the plurality of positioning members 80 is configured such that a gap is formed between the positioning member 80 and a corresponding pair of tooth portions 4 in the state in which the plurality of block bodies B are laminated on the welding jig 70. In a pair of tooth portions 4 in a part of a certain block body B, one of the pair of tooth portions 4 may be in contact with the positioning member 80.

Here, any one selected from the plurality of positioning members 80 is referred to as a “positioning member 80A”, and another one different from the positioning member 80A is referred to as a “positioning member 80B”. That is, the plurality of positioning members 80 include the positioning member 80A (first positioning portion) and the positioning member 80B (second positioning portion). The positioning member 80A regulates circumferential positions of a pair of adjacent tooth portions 4 (first portions) among the plurality of tooth portions 4 of each of the plurality of block bodies B. The positioning member 80B regulates circumferential positions of another pair of adjacent tooth portions 4 (second portions) among the plurality of tooth portions 4 of each of the plurality of block bodies B. When the plurality of block bodies B are laminated on the welding jig 70, gaps are formed respectively between the positioning member 80A and the corresponding pair of tooth portions 4 (a pair of first tooth portions) and between the positioning member 80B and the corresponding pair of tooth portions 4 (a pair of second tooth portions).

Each of the plurality of positioning members 80 is formed in such a size that a gap is provided between the positioning member and the corresponding pair of tooth portions 4. Although a gap is formed between the positioning member 80 and the corresponding pair of tooth portions 4, the positioning member 80 is not inserted between the corresponding pair of tooth portions 4 at the time of laminating unless an angle around the axis Ax of the block body B is within a certain range. That is, when the angle of the block body B around the axis Ax is not within the certain range, the positioning member 80 interferes with all of the tooth portions 4 at the time of laminating, and the block body B is not laminated on the welding jig 70. Therefore, each of the plurality of positioning members 80 defines a circumferential position of the block body B on the welding jig 70. Each of the plurality of positioning members 80 is configured such that a gap is also formed between the positioning member 80 and a portion of the inner circumferential surface of the yoke portion 2 positioned between the corresponding pair of tooth portions 4.

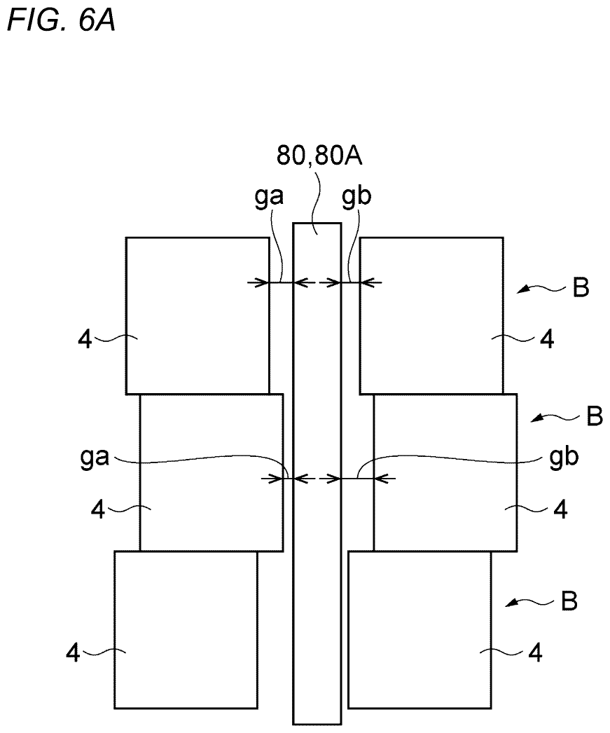

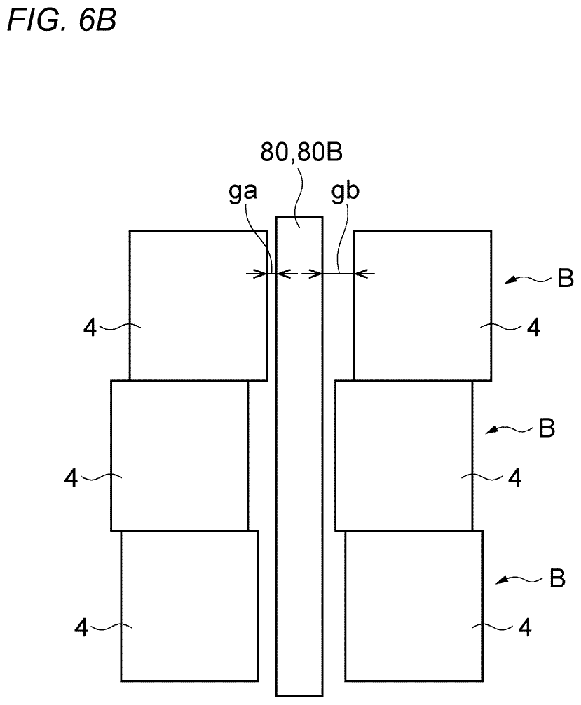

FIG. 6A shows a side view of the positioning member 80A and the corresponding pair of tooth portions 4 when viewed from the axis Ax toward the outside (when viewed from an arrow “V1” in FIG. 5). FIG. 6B shows sides of the positioning member 80B and the corresponding pair of tooth portions 4 when viewed from the axis Ax toward the outside (when viewed from an arrow “V2” in FIG. 5). FIGS. 6A and 6B show an example in which three block bodies B are laminated.

When attention is paid to the positioning member 80A which is one of the positioning members 80, the circumferential positions of the pair of tooth portions 4 regulated by the positioning member 80A are different among the plurality of block bodies B. One of causes of the position deviation is an individual difference in a formation position of the tooth portion 4. Further, the inner edge or an outer edge of the yoke portion 2 (a virtual circle defined by inner circumferential surfaces of the plurality of tooth portions 4) is not a true circle but an elliptical shape close to a true circle in a top view due to a manufacturing error or the like. Therefore, when the above-described rotational lamination is performed, a position deviation may occur between the tooth portions 4 laminated on each other. Then, when each of the block bodies B is placed on the welding jig 70 such that the positioning member 80 is inserted between the corresponding pair of tooth portions 4, a position deviation (lamination misalignment) may occur between the corresponding tooth portions 4 when attention is paid to one of the positioning members 80.

Here, a gap between one positioning member 80 and one in the corresponding pair of tooth portions 4 is denoted by “ga”, and a gap between the positioning member 80 and the other in the corresponding pair of tooth portions 4 is denoted by “gb”. A size of the gap between the positioning member 80 and the corresponding pair of tooth portions 4 can be represented by a total value of a size of the gap ga and a size of the gap gb. The size of the gap ga is defined by a shortest distance between the positioning member 80 and the one tooth portion 4. The size of the gap gb is defined by a shortest distance between the positioning member 80 and the other tooth portion 4.

When attention is paid to the positioning member 80A, a total value of the size of the gap ga and the size of the gap gb with respect to one block body B may be substantially the same as a total value of the size of the gap ga and the size of the gap gb with respect to another block body B. In other words, a size of a gap between the positioning member 80A and the corresponding pair of tooth portions 4 of one block body B may be substantially the same as a size of a gap between the positioning member 80A and the corresponding pair of tooth portions 4 of another block body B. Among all of the block bodies B, the size of the gap between the positioning member 80A and the corresponding pair of tooth portions 4 may be substantially the same.

The size of the gap between the positioning member 80A and the corresponding pair of tooth portions 4 may be substantially the same as a size of a gap between the positioning member 80B, which is another positioning member 80, and a pair of tooth portions 4 corresponding to the positioning member 80B. In this case, a total value of the size of the gap ga and the size of the gap gb in the positioning member 80A may be substantially the same as a total value of the size of the gap ga and the size of the gap gb in another positioning member 80. In the present disclosure, the sizes of the gaps (or the total value of the sizes of the gaps) being substantially the same means that a size (total value) of one gap is 0.95 times to 1.05 times a size (total value) of another gap.

The positioning member 80A which is one of the plurality of positioning members 80 may be provided at a position that is asymmetric to the positioning member 80B which is another positioning member with respect to the axis Ax. The asymmetric position means a position where one member does not overlap a virtual straight line connecting another member and the axis Ax in a top view. The positioning member 80A and the positioning member 80B may be disposed at positions separated from each other by an angle different from 180°(for example, an angle smaller than 175°) in the circumferential direction around the axis Ax. By disposing at least two of the positioning members 80 at asymmetric positions, the positioning member 80A does not regulate movement of the block body B in the radial direction passing through the positioning member 80A, but the movement of the block body B in the radial direction can be regulated by the positioning member 80B. Further, the positioning member 80B does not regulate movement of the block body B in the radial direction passing through the positioning member 80B, but the movement of the block body B in the radial direction can be regulated by the positioning member 80A.

Returning to FIG. 4A, the welding machine 76 in the welding device 60 performs welding at predetermined welding locations of the laminate 1A, which is formed by laminating the plurality of block bodies B on the welding jig 70, such that the plurality of block bodies B are fixed to each other. The welding machine 76 may perform welding by any welding method. An example of the welding method is an arc welding method. The arc welding method may be of a consumable electrode type in which an electrode is melted and used as a filler metal, or may be of a non-consumable electrode type in which a non-consumed electrode is used and a filler metal is additionally added. An example of the non-consumable electrode type welding is TIG welding.

The welding machine 76 may perform welding in a state in which the laminate 1A formed on the welding jig 70 is pressurized in the lamination direction. The welding jig 70 may include an upper plate placed above the laminate 1A and a drive unit that drives the upper plate to approach or to be separated from the lower plate 72. The laminate 1A may be pressurized in the lamination direction by the drive unit moving the upper plate to approach the lower plate 72.

### Method for Manufacturing Laminated Iron Core

Next, a method for manufacturing the laminated iron core 1 will be described with reference to FIGS. 3 to 5. First, a step (forming step) of punching the metal sheet MS along a predetermined shape to form a plurality of block bodies B is performed. For example, as shown in FIG. 3, based on the operation instruction from the controller 100, the pressing device 40 forms the block body B by laminating a plurality of punched members W while sequentially punching the metal sheet MS. The block body B discharged from the pressing device 40 is conveyed individually or together with other block bodies B to the welding device 60 by the conveyor 50.

Next, a step (laminating step) of laminating a plurality of block bodies B on the welding jig 70 is performed (see FIGS. 4A and 4B). In the laminating step, the plurality of block bodies B may be laminated on the welding jig 70 while relatively shifting the reference positions of the plurality of block bodies B in the circumferential direction. The laminating of the plurality of block bodies B on the welding jig 70 (setting of the plurality of block bodies B on the welding jig 70) may be performed by a device such as a robot, or may be performed manually.

In the step of laminating the plurality of block bodies B, first, the first block body B is set on the welding jig 70. The first block body B is set on the welding jig 70 such that each of the plurality of positioning members 80 is inserted between the corresponding pair of tooth portions 4 in a state in which one main surface faces the upper surface of the lower plate 72. Thereafter, a second block body B is overlapped on the first block body B on the welding jig 70 such that the position of the reference position of the second block body B in the circumferential direction is different by a predetermined angle from the position (angle) of the reference position of the first block body B in the circumferential direction. The second block body B is also set on the welding jig 70 such that each of the plurality of positioning members 80 is inserted between the corresponding pair of tooth portions 4 of the second block body B.

A third and subsequent block bodies B are also sequentially set on the welding jig 70 such that each of the positioning members 80 is inserted between the corresponding pair of tooth portions 4 while shifting the angle of the reference position by a predetermined angle with respect to the reference position of an immediately preceding block body B. When being set on the welding jig 70, the plurality of positioning members 80 regulate the positions of the plurality of block bodies B in the circumferential direction to perform positioning in the circumferential direction. Since the rotational lamination is performed in the step of laminating the plurality of block bodies B, the angles (positions in the circumferential direction) of the reference positions are different from each other between the block bodies B adjacent to each other in the laminate 1A formed on the welding jig 70.

After the plurality of block bodies B are laminated on the welding jig 70, positioning in the radial direction is further performed by the diameter-increasing member 74. For example, the plurality of expansion and retraction portions 74a move outward from the axis Ax in the radial direction. Therefore, an outer circumferential surface of each of the expansion and retraction portions 74a comes into contact with each of the inner circumferential surfaces of the plurality of block bodies B laminated on the welding jig 70. Accordingly, an outward force is applied to each of the block bodies B. The welding jig 70 includes, for example, a member that positions the outer circumferential surfaces of the plurality of block bodies B along the radial direction. When the outward force in the radial direction is applied by the plurality of expansion and retraction portions 74a, the plurality of block bodies B (laminate 1A) are sandwiched between the expansion and retraction portions 74a and the positioning members on an outer circumferential surface side in the radial direction. As a result, the plurality of block bodies B are positioned in the radial direction.

Next, a step (welding step) of welding the plurality of block bodies B in a state of being laminated on the welding jig 70 is performed. In the welding step, for example, the upper plate of the welding jig 70 is placed on the laminate 1A formed on the welding jig 70. Then, the drive unit lowers the upper plate toward the laminate 1A (lower plate 72). Accordingly, in a state in which the laminate 1A is sandwiched between the lower plate 72 and the upper plate, a load of a predetermined magnitude is applied to the laminate 1A. In a state in which the load is applied to the laminate 1A (in a state in which the laminate 1A is pressurized), the laminate 1A is welded by the welding machine 76. By the welding of the welding machine 76, for example, a plurality of weld beads 9 extending along the lamination direction are formed (see FIG. 1). The laminated iron core 1 (stator laminated iron core) is manufactured by the above steps.

### Modification

The disclosure in this description should be considered to be illustrative and not restrictive in all respects. Various omissions, substitutions, or modifications may be made to the above examples without departing from the scope of the claims and the gist thereof.

The punched members W in the block body B may be connected or joined to each other by various known methods instead of the caulking portions. The plurality of punched members W in the block body B may be connected to each other using an adhesive or a resin material. Alternatively, the block body B may be obtained by providing temporary caulking to the punched member W, connecting the plurality of punched members W to each other via the temporary caulking to obtain a temporary laminate, and then removing the temporary caulking from the temporary laminate. The “temporary caulking” means caulking that is used to temporarily integrate the plurality of punched members W and is removed in the process of manufacturing a product (the laminated iron core 1).

In the above-described example, the plurality of block bodies B are laminated in the welding device 60, but the plurality of block bodies B may be laminated using a part of the welding jig 70 before being conveyed by the conveyor 50. Before the conveyance using the conveyor 50, a part of the welding jig 70 (for example, a part including the lower plate 72 and the plurality of positioning members 80) may be used as a conveyance member. Before the conveyance using the conveyor 50, the laminate 1A may be formed by performing rotational lamination on the plurality of block bodies B on the conveyance member while rotating. The conveyance member in a state in which the laminate 1A is formed may be conveyed to the welding device 60 by the conveyor 50.

In the above-described example, a cross-sectional shape of the positioning member 80 perpendicular to the axis Ax is a circular shape. The cross-sectional shape of each of the plurality of positioning members 80 may be an elliptical shape or a polygonal shape (for example, a square shape). The cross-sectional shapes of the positioning members 80 may be different from each other. The welding jig 70 may not include the diameter-increasing member 74.

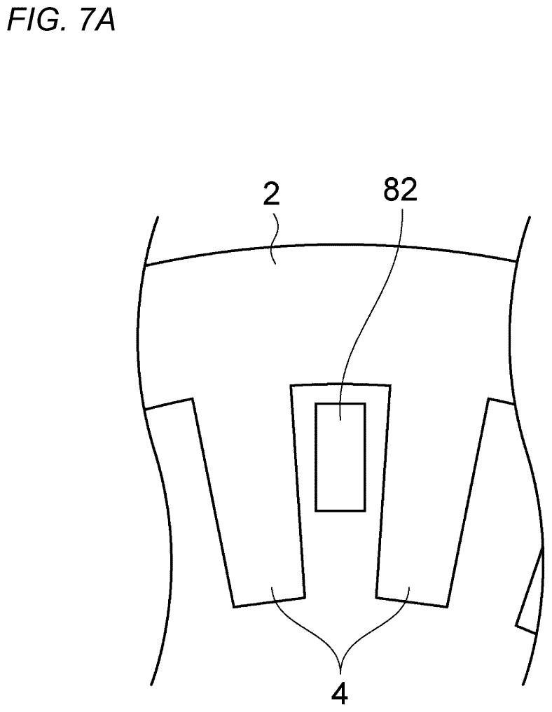

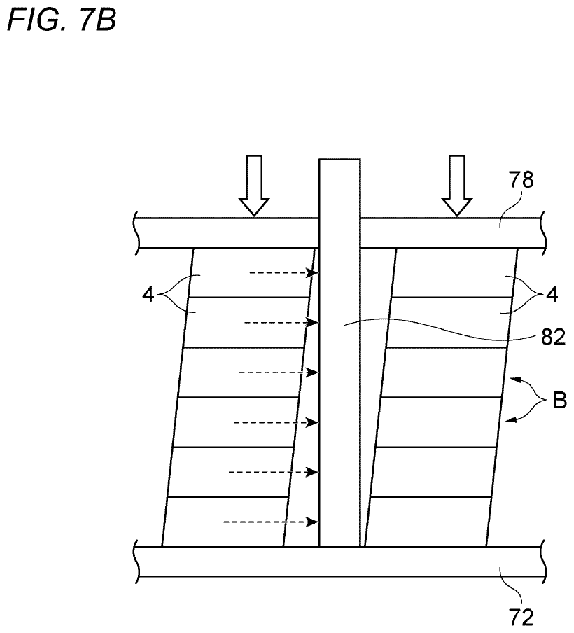

As shown in FIG. 7A, the welding jig 70 may include a plurality of positioning members 82 instead of the plurality of positioning members 80. In FIG. 7A, one positioning member 82 among the plurality of positioning members 82 is shown. Each of the plurality of positioning members 82 is formed such that a cross-sectional shape thereof perpendicular to the axis Ax (an extending direction of the positioning member 82) extends along the radial direction. In the example, one positioning member 82 among the plurality of positioning members 82 constitutes a first positioning portion, and another positioning member 82 constitutes a second positioning portion. The cross-sectional shape of the positioning member 82 may be a square shape such that at least a part of the plurality of positioning members 82 forms a block shape.

As shown in FIG. 7B, even when the positioning is performed by the diameter-increasing member 74 and the positioning member 82, the laminate 1A in which the plurality of block bodies B are laminated may be obliquely inclined (tilted). After the laminate 1A is formed on the welding jig 70, the upper plate 78 is placed on the laminate 1A, and a load is applied (pressurized) to the laminate 1A in the lamination direction. Depending on a degree of the inclination in the laminate 1A, when the load is applied, a force in a horizontal direction (a direction along the upper surface of the lower plate 72) may be applied to the positioning member as indicated by dashed arrows in FIG. 7B. As a result, there is a possibility that the positioning member is obliquely inclined, and lamination misalignment in the circumferential direction among the plurality of block bodies B increases. In contrast, when the cross-sectional shape of the positioning member 82 extends along the radial direction, rigidity of the positioning member 82 is improved, and the possibility that the positioning member is inclined obliquely can be reduced.

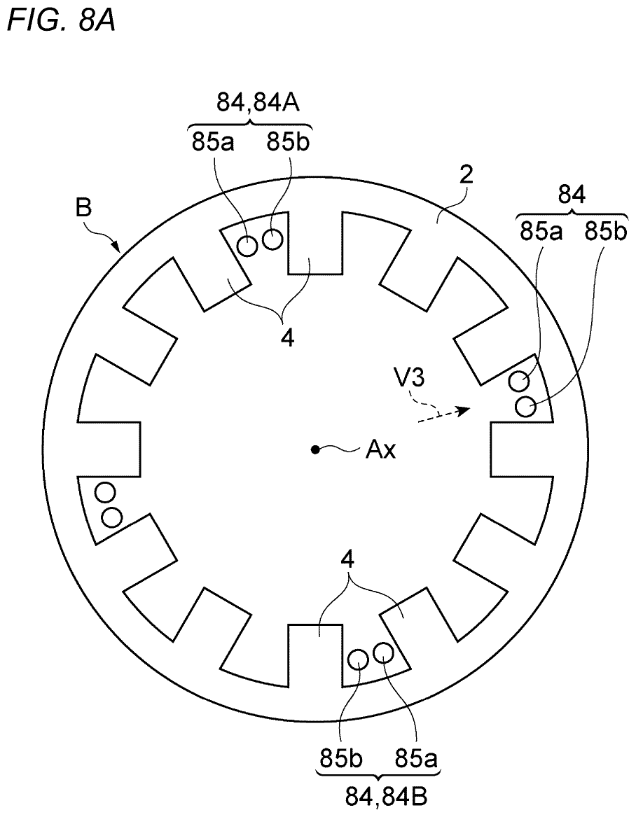

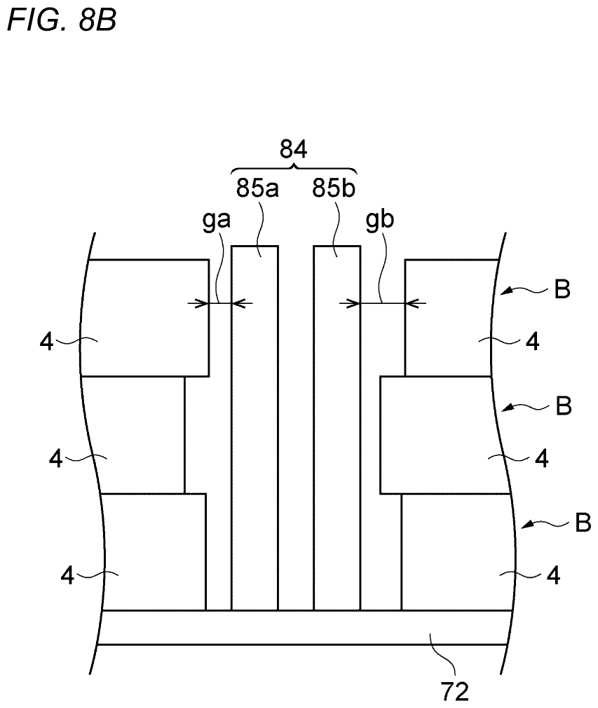

In the above-described example, the positions of a pair of adjacent tooth portions 4 in the circumferential direction are regulated by one positioning member, but the positions of the corresponding pair of tooth portions 4 in the circumferential direction may be regulated by two or more members. As shown in FIGS. 8A and 8B, the welding jig 70 may include a plurality of positioning members 84 instead of the plurality of positioning members 80. Each of the plurality of positioning members 84 may include two or more positioning pins.

In one example, each of the plurality of positioning members 84 includes a positioning pin 85a and a positioning pin 85b. As shown in FIG. 8A, in a top view, the positioning pin 85a and the positioning pin 85b are disposed in a state of being separated from each other. The positioning pin 85a and the positioning pin 85b are disposed adjacently on a circumference centered on the axis Ax. The positioning pin 85a and the positioning pin 85b are positioned between a pair of adjacent tooth portions 4 in the state in which the plurality of block bodies B are laminated on the welding jig 70. The positioning pin 85a and the positioning pin 85b regulate the positions of the corresponding pair of tooth portions 4 in the circumferential direction.

In the state in which the plurality of block bodies B are laminated on the welding jig 70, a gap is formed between the positioning member 84 including the positioning pin 85a and the positioning pin 85b and the corresponding pair of tooth portions 4. In the state in which the plurality of block bodies B are laminated on the welding jig 70, the positioning pin 85a is positioned closer to one in the pair of tooth portions 4, and the positioning pin 85b is positioned closer to the other in the pair of tooth portions 4. FIG. 8B is a side view seen from an arrow “V3” in FIG. 8A. As shown in FIG. 8B, a gap is formed between the positioning pin 85a and one tooth portion 4, and a gap is formed between the positioning pin 85b and the other tooth portion 4. The gap between the positioning pin 85a and the one tooth portion 4 corresponds to the gap ga in FIGS. 6A and 6B, and the gap between the positioning pin 85b and the other tooth portion 4 corresponds to the gap gb in FIGS. 6A and 6B.

When attention is paid to one of the positioning members 84, a total value of the size of the gap ga and the size of the gap gb may be substantially the same among the plurality of block bodies B, as in the case where the welding jig 70 shown in FIG. 4A or FIG. 5 is used. As in the case where the welding jig 70 shown in FIG. 4A or FIG. 5 is used, a total value of the sizes of the gap ga and the gap gb in one positioning member 84 may be substantially the same as a total value of the sizes of the gap ga and the gap gb in another positioning member 84.

Any one selected from the plurality of positioning members 84 is referred to as a “positioning member 84A”, and another one is referred to as a “positioning member 84B”. A size of the gap between the positioning member 84A and the pair of tooth portions 4 corresponding to the positioning member 88A may be substantially the same as a size of the gap between the positioning member 84B and the pair of tooth portions 4 corresponding to the positioning member 84B. In this case, a total value of the size of the gap ga and the size of the gap gb in the positioning member 84A (first positioning portion) may be substantially the same as a total value of the size of the gap ga and the size of the gap gb in the positioning member 84B (second positioning portion). When setting the block body B on the welding jig 70, it is necessary to overlap the block body B with the welding jig 70 while inserting each of the plurality of positioning members 84 (for example, the plurality of sets of positioning pins 85a and 85b) between a pair of tooth portions 4. In this case, the positions of the plurality of block bodies B in the circumferential direction are regulated by the plurality of positioning members 84, and positioning in the circumferential direction is performed. In a case where a pair of tooth portions 4 whose positions in the circumferential direction are regulated by the positioning member 84A constitutes a pair of first tooth portions, a pair of tooth portions 4 whose positions in the circumferential direction are regulated by the positioning member 84B constitutes a pair of second tooth portions.

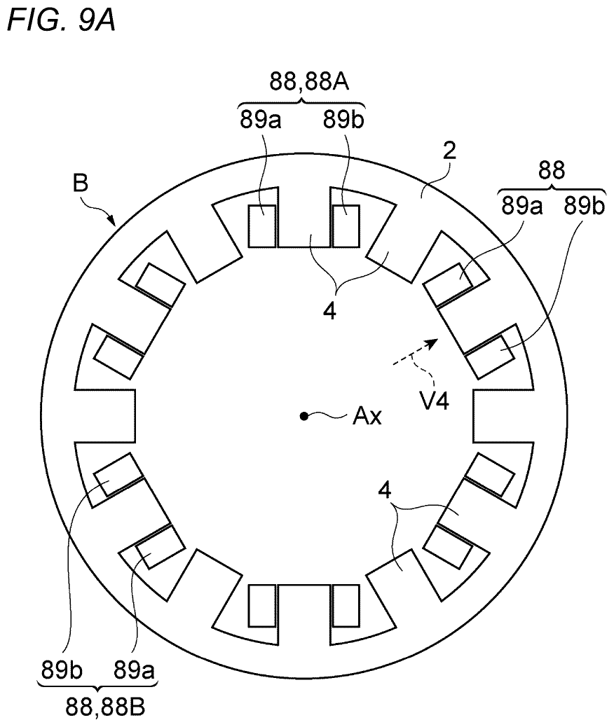

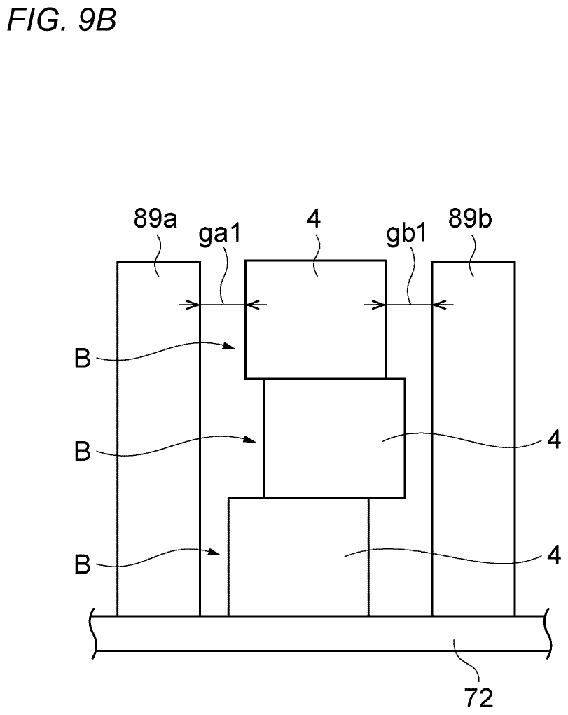

In the above-described example, one positioning member regulates the positions of the corresponding pair of tooth portions 4 in the circumferential direction, but the positioning members may regulate the position of the tooth portion 4 in the circumferential direction with a corresponding one of the tooth portions 4 interposed between the positioning members. As shown in FIGS. 9A and 9B, the welding jig 70 may include a plurality of positioning members 88 instead of the plurality of positioning members 80. Each of the plurality of positioning members 88 includes, for example, a positioning block 89a and a positioning block 89b.

As shown in FIG. 9A, in a top view, the positioning block 89a and the positioning block 89b are disposed in a state of being separated from each other. The positioning block 89a and the positioning block 89b are disposed adjacently on a circumference centered on the axis Ax. The positioning block 89a and the positioning block 89b are positioned to sandwich one tooth portion 4 therebetween in the state in which the plurality of block bodies B are laminated on the welding jig 70. The positioning block 89a and the positioning block 89b regulate a position of the one corresponding tooth portion 4 in the circumferential direction. In a case where the welding jig 70 including the plurality of positioning members 88 is used, one positioning member 88 among the plurality of positioning members 88 constitutes a first positioning portion that regulates a circumferential position of one tooth portion 4 (first portion) corresponding to the positioning member 88. Further, another positioning member 88 among the plurality of positioning members 88 constitutes a second positioning portion that regulates a circumferential position of another tooth portion 4 (second portion) corresponding to the positioning member 88.

In the state in which the plurality of block bodies B are laminated on the welding jig 70, a gap is formed between the positioning member 88 including the positioning block 89a and the positioning block 89b and the one corresponding tooth portion 4. In a part of the tooth portions 4 of a certain block body B, the tooth portion 4 may be in contact with any one of the positioning block 89a and the positioning block 89b.

FIG. 9B is a side view seen from an arrow “V4” in FIG. 9A. As shown in FIG. 9B, a gap ga1 is formed between the positioning block 89a and the tooth portion 4, and a gap gb1 is formed between the positioning block 89b and the tooth portion 4. A size of the gap between the positioning member 88 including the positioning block 89a and the positioning block 89b and the corresponding tooth portion 4 is represented by a total value of a size of the gap ga1 and a size of the gap gb1. The size of the gap ga1 is defined by a shortest distance between the positioning block 89a and the corresponding tooth portion 4. The size of the gap gb1 is defined by a shortest distance between the positioning block 89b and the corresponding tooth portion 4.

When attention is paid to one of the positioning members 88, a total value of the size of the gap ga1 and the size of the gap gb1 in one block body B may be substantially the same as a total value of the size of the gap ga1 and the size of the gap gb1 in another block body B. In other words, a size of the gap between the positioning member 88 and the corresponding pair of tooth portions 4 of one block body B may be substantially the same as a size of the gap between the positioning member 88 and the corresponding pair of tooth portions 4 of another block body B. Among all of the block bodies B, the size of the gap between the positioning member 88 and the one corresponding tooth portion 4 (the total value of the size of the gap ga1 and the gap gb1) may be substantially the same.

Any one selected from the plurality of positioning members 88 is referred to as a “positioning member 88A”, and another one is referred to as a “positioning member 88B”. A size of the gap between the positioning member 88A and the tooth portion 4 (first tooth portion) corresponding to the positioning member 88A may be substantially the same as a size of the gap between the positioning member 88B and the tooth portion 4 (second tooth portion) corresponding to the positioning member 88B. In this case, a total value of the size of the gap ga1 and the size of the gap gb1 in the positioning member 88A may be substantially the same as a total value of the size of the gap ga1 and the size of the gap gb 1 in the positioning member 88B. When setting the block body B on the welding jig 70, it is necessary to overlap the block body B with the welding jig 70 while inserting the corresponding tooth portion 4 between the positioning block 89a and the positioning block 89b of each of the plurality of positioning members 88. In this case, the positions of the plurality of block bodies B in the circumferential direction are regulated by the plurality of sets of positioning blocks 89a and positioning blocks 89b (plurality of positioning members 88), and positioning in the circumferential direction is performed.

In the above-described example, the plurality of block bodies B are fixed to each other by welding the laminate 1A after the laminate 1A is formed on a jig such as the welding jig 70, but the plurality of block bodies B may be fixed to each other by a method other than welding. When fixing the plurality of block bodies B to each other by a method other than welding, a laminating jig (jig) in which a plurality of positioning members 80, 82, 84, and 88 are provided on the lower plate 72 may be used. Examples of the method other than welding include a method of fixing the plurality of block bodies B by laminating and pressing the plurality of block bodies B while applying an adhesive thereon, and a method of fixing the plurality of block bodies B by solidifying molten resin to form a resin portion.

The laminate may be formed by laminating the punched members W one by one using the welding jig 70 or a jig such as the laminating jig. In this case, each of the plurality of punched members W (each punched member W) in the laminate constitutes an iron core member. The punched members W adjacent to each other in the laminate may be connected by welding, application of an adhesive, a method using an adhesive steel plate, or a method of forming a resin portion.

The temporary laminate may be formed by laminating the plurality of punched members W after the plurality of punched members W are formed in the pressing device 40. Then, the punched member W may be taken out one by one from the temporary laminate, an adhesive may be applied to the main surfaces of the punched members W, and the plurality of punched members W may be overlapped in order on the laminating jig. After the plurality of punched members W to which the adhesive is applied are laminated to form the laminate on the laminating jig, the laminate may be pressurized in the lamination direction. In the example, the punched members W adjacent to each other in the lamination direction are fixed by the applied adhesive.

The metal sheet MS punched out by the pressing device 40 may include a coating film having an adhesion function. The metal sheet MS (adhesive steel plate) on which the coating film having the adhesion function is formed may be punched out by the pressing device 40, whereby a plurality of punched members W each including the coating film may be formed. The plurality of punched members W each including the coating film may be laminated on the laminating jig to form the laminate. The pressing device 40 may cure the coating film having the adhesion function by heating while pressing the laminate in the lamination direction on the laminating jig after the laminate is formed on the laminating jig. When the coating film is cured, the punched members W adjacent to each other in the lamination direction are fixed (integrated).

In the above-described example, when positioning the block body B in the circumferential direction, the circumferential position of the tooth portion 4 is regulated by the positioning member of a jig such as the welding jig 70, but a circumferential position of a portion other than the tooth portion 4 may be regulated by the positioning member of the jig. In one example, a circumferential position of a positioning groove provided on the outer circumferential surface of the yoke portion 2, or a circumferential position of a through hole formed in a bulging portion provided on the outer circumferential surface of the yoke portion 2 may be regulated by the positioning portion of the jig. In a state in which a plurality of block bodies B or a plurality of punched members W are laminated on the jig, a gap may be formed between the positioning portion and the positioning groove and the through hole (a surface defining the groove and the through hole).

In the above-described example, an example in which the laminated iron core 1 is a stator core (stator laminated iron core) is described, but the laminated iron core 1 may be a rotor core (rotor laminated iron core). The rotor core may have a columnar shape, and a center hole (through hole) extending in the lamination direction may be formed in the core. The block body B and the punched member W may each have a shape corresponding to the rotor laminated iron core. In a case where the laminated iron core 1 is a rotor core, a plurality of block bodies B or a plurality of punched members W are also laminated on a jig provided with a plurality of positioning portions that regulate a position in the circumferential direction. Circumferential positions of positioning grooves provided on the outer circumferential surface or the inner circumferential surface of the block body B or the like, or circumferential positions of the through holes such as magnet holes in each of which a permanent magnet is disposed, may be regulated by a plurality of positioning portions of a jig.

At least a part of the items described in one of the various examples described above, may be applied to another example.

### Effects of Embodiment

The method for manufacturing the laminated iron core 1 described above includes the forming step of forming a plurality of iron core members by punching the metal sheet MS along a predetermined shape; and a laminating step of laminating the plurality of iron core members on a jig including the first positioning portion and the second positioning portion arranged at different positions in the circumferential direction around the predetermined axis Ax. The first positioning portion regulates a position of a first portion of each of the plurality of iron core members in the circumferential direction. The second positioning portion regulates a position of a second portion of each of the plurality of iron core members in the circumferential direction. In the laminating step, the plurality of iron core members are laminated on the jig such that a gap is provided between the first portion and the first positioning portion, and between the second portion and the second positioning portion.

For example, as in the technique described in Patent Literature 1, in a case where tooth portions at two locations are respectively fitted to two positioning portions (between two sets of positioning pins), due to a manufacturing error or the like, the punched member (core material) may interfere with the positioning portions and may not be able to be set on the jig. Further, when the plurality of iron core members are laminated on the jig, as a method for performing positioning in the circumferential direction, it is considered to perform the positioning with one location of each of the plurality of iron core members (for example, one tooth portion of each of the plurality of iron core members constituting the stator laminated iron core: hereinafter, referred to as a “target location”) as a reference. In this method, by abutting the positioning member at the target location in the circumferential direction, positions of the target locations of the plurality of iron core members in the circumferential direction are aligned. However, at another location of each of the plurality of iron core members (for example, another tooth portion of each of the plurality of iron core members) which corresponds to the target location and is located at a different position in the circumferential direction, the lamination misalignment in the circumferential direction increases due to the manufacturing error or the like. In one example, in a case where the plurality of iron core members constitute a stator laminated iron core, the lamination misalignment increases at a tooth portion other than a reference tooth portion which is the target location. As a result, when considering an entire laminated iron core, a maximum value of a scale indicating magnitude of the lamination misalignment between the tooth portions overlapping each other may increase.

In contrast to the method for performing the positioning in the circumferential direction with one location as a reference, in the method for manufacturing the laminated iron core 1 described above, when the plurality of iron core members are laminated on the jig, a gap is provided between the first portion and the first positioning portion and between the second portion and the second positioning portion. Accordingly, when the iron core members are laminated on the jig, the positions of the first portions of the plurality of iron core members in the circumferential direction and the positions of the second portions of the plurality of iron core members in the circumferential direction are each adjusted within a range defined by the positioning members. Therefore, as in the method described above, the lamination misalignment is extremely small in the first portion, but the lamination misalignment is less likely to increase in the second portion. As a result, a degree of the lamination misalignment as a whole can be reduced in the plurality of iron core members laminated on the jig. In other words, in the plurality of iron core members on the jig, the maximum value of the scale indicating the magnitude of the lamination misalignment at portions where the positions of the plurality of iron core members in the circumferential direction are desired to be aligned can be reduced. Therefore, the present manufacturing method is useful in reducing the lamination misalignment.

The manufacturing method described above may further include a welding step of welding the plurality of iron core members in a state of being laminated on the jig. In the method, the welding can be performed in a state in which the positions of the plurality of iron core members in the circumferential direction are reduced as a whole. As a result, a laminated iron core in a state in which the lamination misalignment is reduced can be obtained.

In the manufacturing method described above, in a state in which the plurality of iron core members are laminated on the jig, a size of the gap between the first portion and the first positioning portion may be substantially the same as a size of the gap between the second portion and the second positioning portion. In this case, the adjustable range defined by the positioning portions when the plurality of iron core members are laminated on the jig are substantially the same between the first portion and the second portion. Therefore, in the plurality of iron core members laminated on the jig, the degree of the lamination misalignment as a whole can be further reduced. Therefore, the manufacturing method is further useful in reducing the lamination misalignment.

In the manufacturing method described above, each of the first positioning portion and the second positioning portion may be formed such that a cross-sectional shape thereof perpendicular to the axis extends along a radial direction of a circle centered on the axis. In this case, rigidity of each of the first positioning portion and the second positioning portion is improved. When the plurality of iron core members on the jig are pressed in the lamination direction, an external force is applied to the positioning portion in a direction intersecting the lamination direction, the positioning portion may be tilted, and the regulation in the position in the circumferential direction by the positioning portions may be released. Meanwhile, in the above method, since the rigidity of the positioning portion is improved, the positioning portion is less likely to be tilted by an external force generated due to the pressure applied in the lamination direction. As a result, a possibility that the regulation in the position by the positioning portion is released is reduced. Therefore, the manufacturing method is further useful in reducing the lamination misalignment.

In the manufacturing method described above, each of the plurality of iron core members may include the yoke portion 2 formed in a ring shape and the plurality of tooth portions 4 each extending to intersect the yoke portion 2. The first portion may be a pair of first tooth portions adjacent to each other among the plurality of tooth portions 4, and the second portion may be a pair of second tooth portions adjacent to each other among the plurality of tooth portions 4. The first positioning portion may be formed to be positioned between the pair of first tooth portions in the circumferential direction when the plurality of iron core members are laminated on the jig. The second positioning portion may be formed to be positioned between the pair of second tooth portions in the circumferential direction when the plurality of iron core members are laminated on the jig. In this case, since the positions of the tooth portions 4 in the circumferential direction are directly adjusted (regulated), it is possible to reduce the lamination misalignment of each of the plurality of tooth portions 4 as compared with a method of performing positioning at a location other than the tooth portions 4. Therefore, the manufacturing method is useful in reducing the lamination misalignment in the tooth portions 4.

In the manufacturing method described above, each of the plurality of iron core members may include the yoke portion 2 formed in a ring shape and the plurality of tooth portions 4 each extending to intersect the yoke portion 2. The first portion may be a first tooth portion among the plurality of tooth portions 4, and the second portion may be a second tooth portion among the plurality of tooth portions 4. The first positioning portion may be formed to sandwich the first tooth portion in the circumferential direction when the plurality of iron core members are laminated on the jig. The second positioning portion may be formed to sandwich the second tooth portion in the circumferential direction when the plurality of iron core members are laminated on the jig. In this case, since the positions of the tooth portions 4 in the circumferential direction are directly adjusted (regulated), it is possible to reduce the lamination misalignment of each of the plurality of tooth portions 4 as compared with a method of performing positioning at a location other than the tooth portions 4. Therefore, the manufacturing method is useful in reducing the lamination misalignment in the tooth portions 4.

The laminating step may include laminating the plurality of iron core members on the jig while relatively shifting a reference position of each of the plurality of iron core members in the circumferential direction. In the method, since so-called rotational lamination is performed, a deviation in a plate thickness is reduced among the plurality of iron core members laminated on the jig. On the other hand, when the rotational lamination is performed, a difference in position in the circumferential direction between the first portions of the plurality of iron core members and between the second portions of the plurality of iron core members may be increased regardless of whether the positioning is performed. As a result, if the positions in the circumferential direction are aligned with one location as a reference, the difference in position in the circumferential direction at other locations of the plurality of iron core members may increase. Meanwhile, in the method for manufacturing the laminated iron core 1 described above, the lamination misalignment as a whole is reduced. Accordingly, it is useful to reduce the lamination misalignment using the present manufacturing method. In a case where an angle of the rotational lamination is 360°/N and N is a natural number of 3 or more, there is a tendency that the difference in position in the circumferential direction increases regardless of whether the positioning is performed, and it is more useful to reduce the lamination misalignment using the present manufacturing method.

### APPENDIX The present disclosure may include methods of Appendix 1 to 7 below.

### Appendix 1

A method for manufacturing a laminated iron core, the method including:
a forming step of forming a plurality of iron core members by punching a metal sheet along a predetermined shape; and
a laminating step of laminating the plurality of iron core members on a jig, the jig including a first positioning portion and a second positioning portion disposed at different positions in a circumferential direction around a predetermined axis, in which
the first positioning portion is configured to regulate a position of a first portion of each of the plurality of iron core members in the circumferential direction,
the second positioning portion is configured to regulate a position of a second portion of each of the plurality of iron core members in the circumferential direction, and
in the laminating step, the plurality of iron core members are laminated on the jig such that a gap is provided between the first portion and the first positioning portion and a gap is provided between the second portion and the second positioning portion.

### Appendix 2

The method according to Appendix 1, further including:
a welding step of welding the plurality of iron core members in a state of being laminated on the jig.

### Appendix 3

The method according to Appendix 1 or 2, in which
in a state in which the plurality of iron core members are laminated on the jig, a size of the gap between the first portion and the first positioning portion is substantially the same as a size of the gap between the second portion and the second positioning portion.

### Appendix 4

The method according to any one of Appendixes 1 to 3, in which
each of the first positioning portion and the second positioning portion is formed such that a cross-sectional shape thereof perpendicular to the axis extends along a radial direction of a circle centered on the axis.

### Appendix 5

The method according to any one of Appendixes 1 to 4, in which
each of the plurality of iron core members includes a yoke portion formed in a ring shape and a plurality of tooth portions extending to intersect the yoke portion,
the first portion is a pair of first tooth portions adjacent to each other among the plurality of tooth portions,
the second portion is a pair of second tooth portions adjacent to each other among the plurality of tooth portions,
the first positioning portion is formed to be positioned between the pair of first tooth portions in the circumferential direction when the plurality of iron core members are laminated on the jig, and
the second positioning portion is formed to be positioned between the pair of second tooth portions in the circumferential direction when the plurality of iron core members are laminated on the jig.

### Appendix 6

The method according to any one of Appendixes 1 to 4, in which
each of the plurality of iron core members includes a yoke portion formed in a ring shape and a plurality of tooth portions extending to intersect the yoke portion,
the first portion is a first tooth portion among the plurality of tooth portions,
the second portion is a second tooth portion among the plurality of tooth portions,
the first positioning portion is formed to sandwich the first tooth portion in the circumferential direction when the plurality of iron core members are laminated on the jig, and
the second positioning portion is formed to sandwich the second tooth portion in the circumferential direction when the plurality of iron core members are laminated on the jig.

### Appendix 7

The method according to any one of Appendixes 1 to 6, in which
the laminating step includes laminating the plurality of iron core members on the jig while relatively shifting a reference position of each of the plurality of iron core members in the circumferential direction.

The present application appropriately refers to the contents disclosed in Japanese Patent Application (Japanese Patent Application No. 2022-119741) filed on Jul. 27, 2022.

### REFERENCE SIGNS LIST

1: laminated iron core
2: yoke portion
4: tooth portion
B: block body
W: punched member
MS: metal sheet
70: welding jig
Ax: axis
80, 82, 84, and 88: positioning member
ga, gb, ga1, gb1: gap

1. A method for manufacturing a laminated iron core, the method comprising:
forming a plurality of iron core members by punching a metal sheet along a predetermined shape; and
laminating the plurality of iron core members on a jig, the jig comprising a first positioning portion and a second positioning portion disposed at different positions in a circumferential direction around a predetermined axis,
wherein the first positioning portion is configured to regulate a position of a first portion of each of the plurality of iron core members in the circumferential direction,
wherein the second positioning portion is configured to regulate a position of a second portion of each of the plurality of iron core members in the circumferential direction, and
wherein in the laminating the plurality of iron core members, the plurality of iron core members are laminated on the jig such that a gap is provided between the first portion and the first positioning portion and a gap is provided between the second portion and the second positioning portion.

2. The method according to claim 1, further comprising:
welding the plurality of iron core members in a state of being laminated on the jig.

3. The method according to claim 1,
wherein in a state in which the plurality of iron core members are laminated on the jig, a size of the gap between the first portion and the first positioning portion is substantially the same as a size of the gap between the second portion and the second positioning portion.

4. The method according to claim 1,
wherein each of the first positioning portion and the second positioning portion is formed such that a cross-sectional shape thereof perpendicular to the axis extends along a radial direction of a circle centered on the axis.

5. The method according to claim 1,
wherein each of the plurality of iron core members comprises a yoke portion formed in a ring shape and a plurality of tooth portions extending to intersect the yoke portion,
wherein the first portion is a pair of first tooth portions adjacent to each other among the plurality of tooth portions,
wherein the second portion is a pair of second tooth portions adjacent to each other among the plurality of tooth portions,
wherein the first positioning portion is formed to be positioned between the pair of first tooth portions in the circumferential direction when the plurality of iron core members are laminated on the jig, and
wherein the second positioning portion is formed to be positioned between the pair of second tooth portions in the circumferential direction when the plurality of iron core members are laminated on the jig.

6. The method according to claim 1,
wherein each of the plurality of iron core members includes a yoke portion formed in a ring shape and a plurality of tooth portions extending to intersect the yoke portion,
wherein the first portion is a first tooth portion among the plurality of tooth portions,
wherein the second portion is a second tooth portion among the plurality of tooth portions,
wherein the first positioning portion is formed to sandwich the first tooth portion in the circumferential direction when the plurality of iron core members are laminated on the jig, and
wherein the second positioning portion is formed to sandwich the second tooth portion in the circumferential direction when the plurality of iron core members are laminated on the jig.

7. The method according to claim 1,
wherein the laminating the plurality of iron core members comprises laminating the plurality of iron core members on the jig while relatively shifting a reference position of each of the plurality of iron core members in the circumferential direction.
